(19) United States
(12) Patent Application Publication
(10) Pub. No.: US 2006/0080692 A1
(43) Pub. Date: Apr. 13, 2006

(54) Optical drive with symmetrical anti-impact structure

(75) Inventors: Shan-Yen Yang, Taoyuan City (TW); Kuo-Chun Lee, Taoyuan County (TW); Xiao-Ning Sun, Suzhou (CN)

Correspondence Address: BIRCH STEWART KOLASCH & BIRCH, PO BOX 747, FALLS CHURCH, VA, 22040-0747, US

(73) Assignee: BENQ CORPORATIN

(21) Appl. No.: 11/229,644

(22) Filed: Sep. 20, 2005

(30) Foreign Application Priority Data
Sep. 24, 2004 (TW) 93128977

(51) Int. Cl. G11B 7/08

(52) U.S. Cl. 720/676

(57) ABSTRACT

An optical drive with symmetrical anti-impact structure. A joint is fixed to an optical pick-up and slidably disposed on a guide bar with both ends supported by a base, and a symmetrical bumper is attached to the joint. When the bumper impacts the base, the joint does not deviate from the sliding direction thereof.

### BACKGROUND

The invention relates to an optical drive, and in particular to an optical drive with a symmetrical bumper.

In general, an optical drive is provided with an optical pick-up (OPU) which moves back and forth to read data on a disc. As shown in FIG. 1, in a conventional optical drive, an OPU 10 is mounted on a frame 5 with one side capable of sliding on a guide bar 8 and another side fixed to a joint 20 by a bolt 9. A screw 50 driven by a stepping motor 60 rotates to slide the joint 20 on a guide bar 30 to move the OPU 10.

When the OPU 10 moves to read outermost or innermost track of a disc, however, the joint 20 may impact a base 40, which supports the guide bar 30, due to erroneous track reading. Frequent impact of the joint 20 can cause damage of the OPU 10. Thus a typical optical drive is often provided with bumpers 25 disposed on both sides of the joint 20 to prevent impact with the base 40.

FIG. 2a is a schematic view showing the joint 20 about to impact the base 40. FIG. 2b is a schematic view showing the joint 20 impacting the base 40. As shown in FIGS. 2a and 2b, one end of the conventional S-shaped bumper 25 can abut the base 40. When the bumper 25 moves in a reverse y direction and impacts the base 40, the s-shaped bumper 25 deforms to absorb shock generated by the impact. As the S shape is asymmetrical, when the bumper 25 impacts the base 40 and elastically deforms, reactive force exerted on the bumper 25 by the base 40 has a component Fx in an x direction (Fy is a component of the reactive force in the y direction). Fx causes the joint 20 to deviate from the y direction for a distance α in the x direction and the guide bar 30 to deform slightly. As the joint 20 is fixed to the OPU 10, the OPU 10 also deviates a distance in the x direction. This deviation in the x direction greatly influences the data reading precision of the OPU 10 because data arrangement on a disc is on the order of micrometers.

### SUMMARY

An optical drive according to an embodiment of the invention comprises a base, a guide bar with both ends supported by the base, an optical pick-up, a joint fixed to the optical pick-up and slidably disposed on the guide bar, and a symmetrical bumper attached to the joint, wherein when the bumper impacts the base, the joint does not deviate from the sliding direction thereof.

### BRIEF DESCRIPTION OF THE DRAWINGS

The invention can be more fully understood by reading the subsequent detailed description and examples with references made to the accompanying drawings, wherein:

FIG. 1 is a schematic view of an OPU with an anti-impact structure of a conventional optical drive;

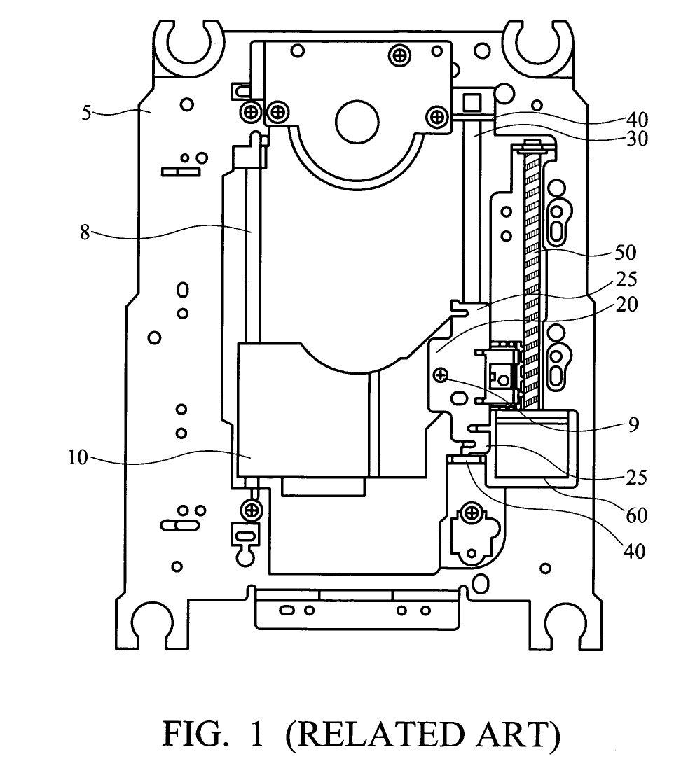

FIG. 2a is a schematic view showing a bumper of a conventional anti-impact structure about to impact a base;

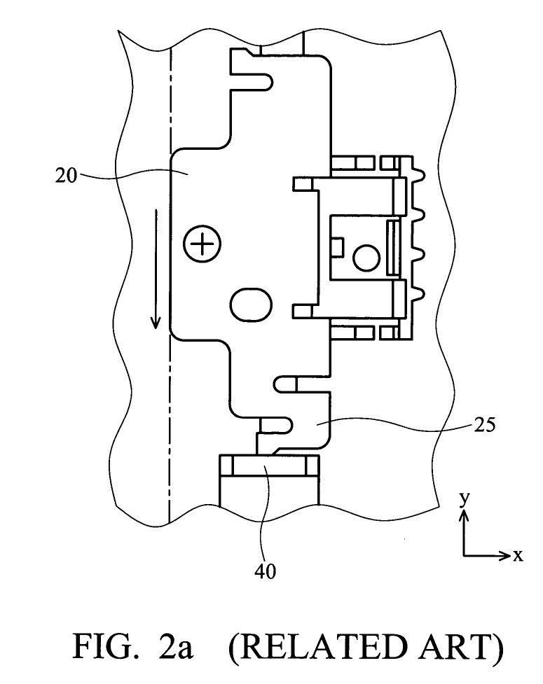

FIG. 2b is a schematic view showing a bumper of a conventional anti-impact structure impacting a base;

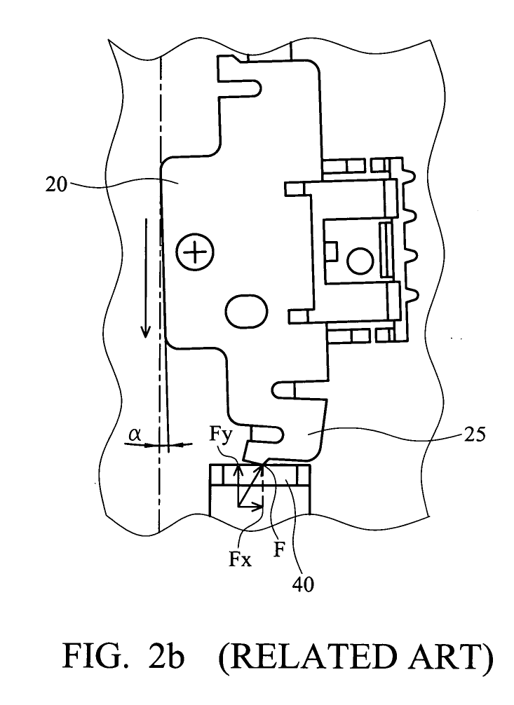

FIG. 3 is a schematic view of an OPU with an anti-impact structure of an embodiment of the invention; and

FIG. 4 is an enlarged view of the joint and the bumper of FIG. 3.

### DETAILED DESCRIPTION

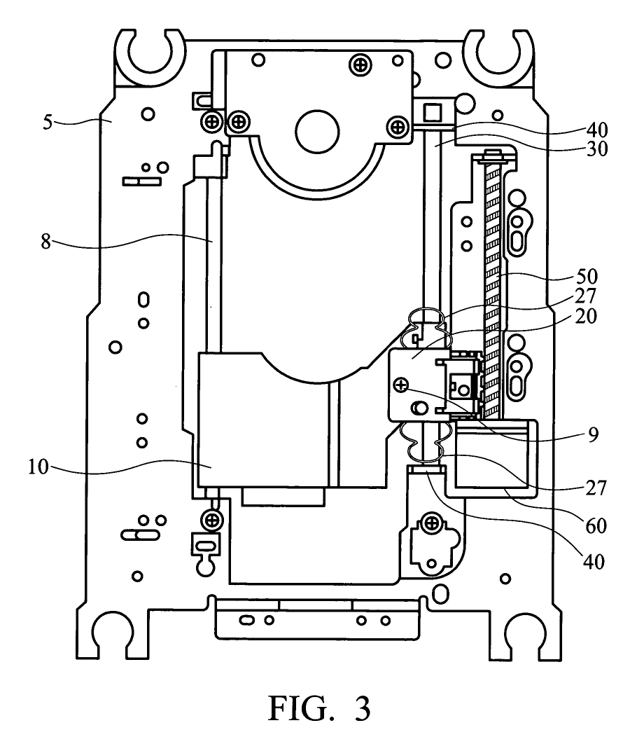

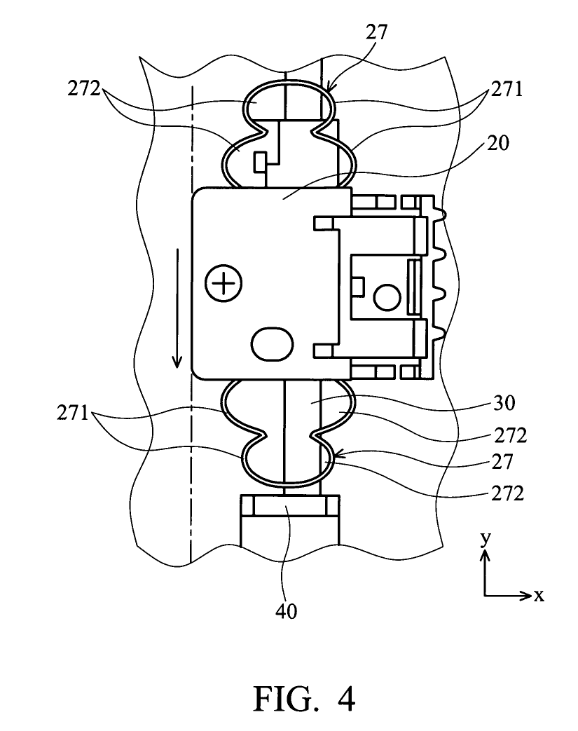

FIG. 3 is a schematic view of an anti-impact structure for an OPU of an embodiment of the invention. As shown in FIG. 3, two bumpers 27 are disposed on two sides of the joint 20. FIG. 4 is an enlarged view of the joint 20 and the bumper 27. As shown in FIG. 4, the bumper 27 comprises a plurality of curved bumper elements 271 joined together to form a symmetrical shape with respect to a sliding direction of the joint 20. Each bumper element 271 comprises an opening 272 which has the same shape as the bumper element 271. Such a structure can act as a spring. The bumper element 271 disposed at the end of the bumper 27 is also curved.

When the bumper 27 impacts the base 40, the end of the bumper 27 is pressed by the base 40 such that the bumper element 271 elastically deforms in a spring-like fashion, thereby preventing the joint 20 from directly impacting the base 40 and absorbing shock generated by impact. As the bumper 27 is symmetrical, the reactive force exerted on the bumper 27 by the base 40 has no component in the x direction, thus the joint 20 does not deviate in the x direction. Thus, the OPU 10 has no deviation in x direction and does not affect the precision of data reading.

In the described embodiment, the bumper elements 271 can comprise plastic. The bumper 27 comprising bumper elements 271 is integrally formed. The material of the bumper 27 is, however, not limited to plastic. Any material capable of elastic deformation, such as metal and the like, is also applicable. The bumper element 271 is not limited to curved shape; any symmetrical shape with respect to the sliding direction of the joint 20 is applicable.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical drive, comprising:
a base;
a guide bar with both ends supported by the base;
an optical pick-up;
a joint fixed to the optical pick-up and slidably disposed on the guide bar;
a symmetrical bumper attached to the joint, wherein when the bumper impacts the base, the joint does not deviate from the sliding direction thereof.

2. The optical drive as claimed in claim 1, wherein the bumper comprises a plurality of bumper elements joined together to form the symmetrical shape thereof.

3. The optical drive as claimed in claim 2, wherein the bumper elements are curved.

4. The optical drive as claimed in claim 2, wherein the bumper comprising the bumper elements is integrally formed.

5. The optical drive as claimed in claim 2, wherein the material of the bumper element comprises plastic.

6. The optical drive as claimed in claim 1, wherein the bumper element comprises an opening.

7. The optical drive as claimed in claim 6, wherein the shape of the opening is the same as the shape of the bumper element.
